(19) United States
(12) Patent Application Publication
(10) Pub. No.: US 2019/0367399 A1
(43) Pub. Date: Dec. 5, 2019

(54) NITROGEN-RICH WASTEWATER TREATMENT APPARATUS USING PARTIAL NITRITATION SEQUENCING BATCH REACTOR TANK LINKED TO AMMONIUM OXIDIZING BACTERIA GRANULE PRODUCTION TANK AND ANAEROBIC AMMONIUM OXIDATION

(71) Applicant: BKT CO., LTD., Daejeon (KR)

(72) Inventors: Min Ki JUNG, Daejeon (KR); Dae Hwan RHU, Yeoju-si (KR); Hong Keun PARK, Mokpo-si (KR); Dong Woo KIM, Yoba Linda, CA (US); Dong Jin JU, Sejong (KR)

(21) Appl. No.: 16/486,164

(22) PCT Filed: Dec. 26, 2017
(86) PCT No.: PCT/KR2017/015455

§ 371 Date: Aug. 15, 2019

(30) Foreign Application Priority Data
Feb. 23, 2017 (KR) 10-2017-0024245

(51) Int. Cl. C02F 9/00

(52) U.S. Cl. CPC C02F 9/00; C02F 3/223

(57) ABSTRACT

The present invention relates to a nitrogen-rich wastewater treatment apparatus using a partial nitritation sequencing batch reactor (SBR) tank, ammonium oxidizing bacteria (AOB) granules and anaerobic ammonium oxidation (ANAMMOX). AOB granules can efficiently be formed by means of a sludge exchange between the SBR tank and an AOB granule production tank. Moreover, partial nitritation is performed by means of allowing the AOB granules to flow into the SBR tank again, nitrogen is quickly removed by means of ANAMMOX without a supply of an external carbon source, and oxygen and an organic material are reduced and a sludge yield decreases compared to an existing method.

### TECHNICAL FIELD

The present invention relates to an apparatus for treating high-concentration nitrogen wastewater using a partial nitritation sequencing batch reactor (SRB) (hereinafter, an “SBR reaction tank”) and an ammonium oxidation bacteria (hereinafter, “AOB”) granule (hereinafter, “AOB granule”) and anaerobic ammonium oxidation (ANAMMOX) process (hereinafter, an “ANAMMOX process”).

More specifically, the present invention relates to a high-concentration nitrogen wastewater treatment apparatus which may efficiently form AOB granules using mutual exchange of sludge between an SBR reaction tank and an AOB granulation tank, reintroduce the formed AOB granules into the SBR reaction tank and perform partial nitritation thereon while simultaneously removing nitrogen using an ANAMMOX process without the need for feeding an external carbon source in a rapid and economic manner.

### BACKGROUND ART

Livestock excretion, food waste, or other high-concentration organic wastewater contains high-concentration solids, organic matter, and nitrogen. An research effort is underway for producing methane, which is a useful energy source, using organics present in sewage.

For recovery of a large amount of methane, as much organic matter present in wastewater as possible is introduced in the anaerobic process and methane production is maximized using acid fermentation and methane fermentation microorganisms in the anaerobic state. However, although organic matter is mostly removed from the discharged wastewater, a high-concentration of nitrogen still remains, and thus the carbon/nitrogen (C/N) ratio stays very low.

Livestock excretion requires a high concentration of biochemical oxygen demand (BOD) in the order of 30,000 mg/L to 50,000 mg/L and is thus treated typically in an anaerobic digestion tank. After anaerobic treatment, wastewater containing high-concentration nitrogen is produced, and the concentration of ammonia nitrogen is very high in the order of 1,500 mg/L to 3,000 mg/L.

Livestock excretion, a major contaminant, is anaerobically treated and then distributed, as a fertilizer, on the farmland. Continuous inflow of livestock excretion into the farmland may contaminate underground water or, if leaking out by rainfalls, it may cause eutrophication and deterioration of water quality.

Conventionally, biological methods have been used for treating nitrogen wastewater and, among them, treatment using a combination of nitrification and denitrification has primarily been adopted. However, such conventional methods require supply of a great amount of oxygen in treating wastewater with a low C/N ratio.

Further, due to the need for an external carbon source for denitrification, they suffer from low economic efficiency in resource recovery.

In biological methods, nitrogen is removed from wastewater while several biochemical reactions are performed stepwise.

As shown in Reaction Formula 1, as air is supplied to ammonia nitrogen which is in reduced state, ammonia nitrogen is oxidized into nitrate nitrogen.

NH₄⁺+1.5O₂→NO₂⁻+2H⁺+H₂O

NO₂⁻+0.5O₂→NO₃⁻

NH₄⁺+2O₂→NO₃⁻+2H⁺+H₂O <Reaction Formula 1>

As shown in Reaction Formula 1, 3.43 mg of oxygen is needed to oxidize 1 mg of ammonia nitrogen into nitrite nitrogen, and 1.14 mg of oxygen is additionally required to oxidize 1 mg of nitrite nitrogen into nitrate nitrogen. Resultantly, 4.57 mg of oxygen is consumed to oxidize 1 mg of ammonia nitrogen into nitrate nitrogen.

The oxidized nitrate nitrogen is discharged, as nitrogen gas, in the air by the reaction as shown in Reaction Formula 2, so that nitrogen is finally removed from the wastewater.

NO₃⁻+1.08CH₃OH+0.24H₂CO₃→0.06C₅H₇O₂N+0.47N₂+1.68H₂O+HCO₃⁻ <Reaction Formula 2>

As can be shown in Reaction Formula 2, denitrification of 1 mg of nitrate nitrogen requires about 4 mg to about 5 mg of chemical oxygen demand (COD), meaning that the COD/NO₃—N ratio needs to be 4.0 to 5.0 or more for normal denitrification.

In particular, since the C/N ratio of high-concentration organic wastewater, such as livestock excretion and food waste is very low in the order of 1 or less, it is necessarily needed to introduce an external carbon source, e.g., methanol or acetic acid. This may raise the operation cost.

To address these issues, a short-cut nitrogen removal process may be applied, which oxidizes only part of ammonia nitrogen into nitrite nitrogen (NO₂⁻) and then removes nitrogen by denitrification which uses the remaining ammonia nitrogen as an electron donor.

Use of this method may advantageously save oxygen by 60% and organic matter by 100%.

Such a short-cut nitrogen removal process is performed by ANAMMOX microorganisms which transform ammonia nitrogen into nitrogen gas using nitrite nitrogen as an electron donor under the anaerobic condition. Transformation by ANAMMOX microorganisms from ammonia nitrogen into nitrogen gas is achieved as shown in Reaction Formula 3 below.

1.0NH₄⁺+1.32NO₂⁻+0.066HCO₃⁻+0.13H⁺→1.02N₂+0.26NO₃⁻+0.066CH₂O_{0.5}N_{0.15}+2.03H₂O <Reaction Formula 3>

As can be seen from Reaction Formula 3, treatment using ANAMMOX adopts nitrite nitrogen as an electron acceptor. Thus, the partial nitritation process which oxidizes part (about 56.5%) of ammonia nitrogen in the wastewater into nitrite nitrogen should be positioned upstream of the short-cut nitrogen removal process.

What matters most in a short-cut nitrogen removal process is to achieve stable partial nitritation.

The concentration of ammonia nitrogen in such high-concentration organic wastewater as livestock excretion and food waste in the anaerobic digestion tank is high in the order of 1,500 mg/L to 3,000 mg/L, and the temperature is also high in the order of 25° C. or higher and, thus, nitritation may easily be achieved.

However, since nitrite nitrogen is rapidly transformed into nitrate nitrogen by nitrite oxidation bacteria (NOB), AOB needs to take dominance to achieve stable nitritation.

Several methods are used to allow AOB to take dominance over NOB. One method among them is to keep the solid retention time (hereinafter, “SRT”) within one day. In other words, the method of operation to maintain the SRT within one day may allow AOB to remain in the system while washing out NOB, so that AOB may take dominance. The reason why such method is possible is that one or more days of doubling time is required for NOB.

The ANAMMOX process is performed by known microorganisms.

ANAMMOX microorganisms which performs a short-cut nitrogen removal reaction are very slow in growth, and their doubling time is very long, e.g., 11 days. Thus, it is very critical to apply a reaction tank which may prevent microorganisms from being washed out so as to stably secure microorganisms.

For a single reaction tank (or reactor) where AOB microorganisms and ANAMMOX microorganisms are simultaneously grown in the same reaction tank to thereby treat wastewater, it is not easy to maintain different SRTs.

Where an AOB reaction tank and an ANAMMOX reaction tank are separated, the optimal operation condition may be achieved for the microorganisms. However, this way increases the number of reaction tanks and requires a separate sedimentation facility for separating microorganisms from wastewater and, thus, requires more unit processes and lots. This also leads to an increase in the number of factors for operation and maintenance.

To address this, granules which react fast and have excellent sedimentability may be used for the treatment process. However, the condition under which granules are formed differs from the condition under which contaminants are treated. Thus, it is technically hard for the AOB and ANAMMOX reaction tanks to form high-sedimentable granules while simultaneously perform stable treatment.

Thus adopted is a method in which microorganisms and granules are produced at the outside using a separate reaction tank and are supplied to the reaction tanks.

Korean Patent No. 10-2002-0072360 (published on September 14, hereinafter, ‘prior document 1’) relates to a high-concentration nitrogen wastewater treatment apparatus and method using partial nitritation and anaerobic ammonia oxidation and discloses a method of treating high-concentration nitrogen wastewater using Nitrosomonas bacteria and ammonia oxidizing bacteria.

The invention disclosed in prior document 1 suffers from difficulty in domination only with Nitrosomonas bacteria, leakage of bacteria when wastewater is introduced or discharged, which results in the reaction slowing down, and the need for installing multiple processes for continuous inflow into the SBR reaction tank, thus increasing operation cost and economic burden.

U. S. Patent Application Publication No. 2015-0336827 (published on Nov. 26, 2015, hereinafter ‘prior document 2’) relates to a biofilm media, treatment system and method of wastewater treatment and discloses a method of treating wastewater using a movable biofilm.

The invention disclosed in prior document 2 suffers from a long recovery time of damaged biofilm and deterioration of wastewater treatment efficiency when microorganisms are overgrown.

Japanese Patent No. 4691938 (published on Jun. 1, 2011, hereinafter ‘prior document 3’) discloses a method and apparatus of treating a nitrogen-containing liquid and discloses a method of treating a nitrogen-containing liquid by performing nitritation using ammonia oxidizing bacteria and denitrification using ANAMMOX bacteria.

The invention disclosed in prior document 3 have difficulty in evenly performing partial nitritation since pH is adjusted by injecting an alkali in the partial nitritation process.

Korean Patent No. 10-0586535 (published on Jun. 8, 2006, hereinafter ‘prior document 4’) relates to an advanced treatment system and method for sewage using a nitrifying bacteria granulation reactor and discloses a method of denitrifying sewage by intermittently introducing nitrifying bacteria granules.

The invention disclosed in prior document 4 may increase nitritation and nitration by supplying nitrifying bacteria to the main reaction tank but, by its process configuration, first gets through an aerobic state after wastewater is introduced. Thus, as organic matter is removed from wastewater, there is no organic matter introduced into the denitrification tank. Thus, denitrification necessarily requires injection of an external carbon source.

Further, since methanol and acetic acid are used as an external carbon source, this is an economic disadvantage.

Moreover, since heterotrophic microorganisms to remove organic matter, including denitrifying microorganisms, grow several times faster than AOB microorganisms, it is unrealistic to allow AOB to take dominance using sludge containing a great quantity of microorganisms.

In other words, where granules are produced by introducing the sludge dominated by heterotrophic microorganisms into the reaction tank, a long time may be taken to produce granules which are dominated by nitritation and nitration microorganisms.

According to the present invention, partial nitritation is performed using an SBR reaction tank which is divided into three sections, and sludge is selectively introduced into an AOB granulation tank. Further, the present invention produces high-purity AOB granules using the AOB granulation tank and stores the AOB granules in a storage tank included in an AOB granulator. Further, the present invention uses an ANAMMOX reaction tank included in the AOB granulation tank to secure a concentration for suspended solids of discharged water and to prevent leakage of AOB, and the present invention uses an SBR reaction tank associated with the AOB granulation tank to treat high-concentration nitrogen wastewater.

Further, the ANAMMOX reaction tank is configured to include a separate ANAMMOX granulation tank, thereby accelerating the denitrifying reaction.

### PRIOR ART DOCUMENTS

(Prior document 1) Korean Patent Application Publication No. 10-2002-0072360 (published on Sep. 14, 2002)

(Prior document 2) U. S. Patent Application Publication No. 2015-0336827 (published on Nov. 26, 2015)

(Prior document 3) Japanese Patent No. 4691938 (published on Jun. 1, 2011)

(Prior document 4) Korean Patent No. 10-0586535 (published on Jun. 8, 2006)

### DETAILED DESCRIPTION OF THE INVENTION

### Technical Problem

To address the foregoing problems of the prior art, the present invention aims to provide a high-concentration nitrogen wastewater treatment apparatus including an SBR reaction tank for easily forming granules and selectively screening sludge, an AOB granulator including an AOB granulation tank and an AOB granules storage tank, and an ANAMMOX reaction tank and using ANAMMOX along with the AOB granulation tank associated with the SBR reaction tank.

An object of the present invention is to achieve stable partial nitritation by introducing AOB-dominated sludge into the AOB granulation tank to thereby produce AOB granules and introducing the produced AOB granules into the SBR reaction tank.

Another object of the present invention is to remove nitrogen without consuming organic matter by introducing the treated water which has undergone partial nitritation in the SBR reaction tank and the AOB granulation tank into the downstream ANAMMOX reaction tank.

Still another object of the present invention is to achieve stable denitrification using an ANAMMOX granulation tank included in the ANAMMOX reaction tank.

### Technical Solution

To achieve the foregoing objectives, according to the present invention, there is provided a high-concentration nitrogen wastewater treatment apparatus including an SBR reaction tank for partial nitritation, an AOB granulator including an AOB granulation tank and an AOB granules storage tank, and an ANAMMOX reaction tank and using ANAMMOX and the SBR reaction tank associated with the AOB granulation tank.

According to the present invention, the SBR reaction tank and the AOB granulation tank are operated in a batch type.

According to the present invention, the SBR reaction tank is divided into three sections, and sludge only in the middle section is selectively discharged. An air lift-type air feeder which is advantageous in maintaining AOB granules is included.

According to the present invention, the ANAMMOX reaction tank includes an upper portion filled with floating media and a lower portion including any one of a completed mixed or upflow and fluidized bed biofilm process through a sludge granule or biofilm process.

According to the present invention, an ANAMMOX granulation tank is separately included in the ANAMMOX reaction tank.

### Advantageous Effects

According to the present invention, the high-concentration nitrogen wastewater treatment apparatus using ANAMMOX and the SBR reaction tank associated with the AOB granulation tank may stably achieve partial nitritation by a combination of partial nitritation and an ANAMMOX process.

According to the present invention, as half of ammonia nitrogen is oxidized up to the NO₂⁻ step, nitrogen is removed by denitrification. Thus, the present invention may save oxygen and organic matter as compared with the conventional methods.

According to the present invention, AOB-dominated sludge is selectively introduced into the AOB granulation tank, thereby producing high-purity AOB granules. Thus, as AOB takes dominance more quickly than NOB, high-concentration nitrogen wastewater may be rapidly treated.

According to the present invention, an air lift-type air feeder is included in the SBR reaction tank. Granules, released or sedimentability reduced, are selectively introduced into the AOB granulation tank and are then reproduced into good AOB granules. Thus, the present invention may reduce the volume of the AOB granulation tank and produce granules in an efficient and selective manner.

Further, according to the present invention, when the reaction in the ANAMMOX reaction tank slows down, the ANAMMOX granules produced in the ANAMMOX granulation tank are supplied to the ANAMMOX reaction tank, thereby leading to an even or uniform denitrification reaction.

### BRIEF DESCRIPTION OF DRAWINGS

FIG. 1 is a view illustrating a short-cut nitrogen removal process for a high-concentration nitrogen wastewater treatment apparatus according to an embodiment of the present invention;

FIG. 2 is a view illustrating a method of operation of an SBR reaction tank and an AOB granulation tank according to an embodiment of the present invention;

FIG. 3 is a view illustrating a method of sequential operations over time in an SBR reaction tank and an AOB granulation tank according to an embodiment of the present invention;

FIG. 4 is a view illustrating a short-cut nitrogen removal process adding an ANAMMOX granulation tank according to an embodiment of the present invention;

FIG. 5 illustrates photos for comparison showing variations in the size of AOB granules as an AOB granulation tank is operated according to an embodiment of the present invention;

FIG. 6 is a graph illustrating the amount of AOB granules produced per ammonia removal amount under a nitrogen influx load condition in an AOB granulation tank according to an embodiment of the present invention; and

FIG. 7 illustrates microscopic photos in which AOB granules in an SBR reaction tank are classified per size according to an embodiment of the present invention.

### DESCRIPTION OF REFERENCE CHARACTERS

110: SBR reaction tank
111: air lift-type air feeder
120: AOB granulator
121: AOB granulation tank
122: AOB granules storage tank
130: ANAMMOX reaction tank
140: ANAMMOX granulation tank
S211: reaction step
S212: sedimentation step
S213: step of discharging supernatant liquid
S214: step of discharging sludge
S221: step of discharging supernatant liquid
S222: step of discharging sludge
S223: step of pausing SBR reaction tank
S24: step of introducing wastewater
S225, S226, and S227: steps of partial nitritation and AOB granulation
S228: step of sedimentation in AOB granulation tank
S229: step of sedimentation in SBR reaction tank

### BEST MODE FOR CARRYING OUT THE INVENTION

Hereinafter, the present invention is described in detail with reference to embodiments thereof. The present invention is not limited to embodiments set forth herein but may rather be embodied in other various forms. The embodiments set forth herein are provided to fully convey the spirit of the present invention to one of ordinary skill in the art to which the present invention pertains. Thus, the present invention should not be limited by the following embodiments and it should be appreciated that all modifications, equivalents, or replacements which belong to the technical spirit and scope of the present invention are included.

Various changes may be made to the present invention, and the present invention may come with a diversity of embodiments. Some embodiments of the present invention are shown and described in connection with the drawings. Relative sizes between the components in the drawings may be slightly exaggerated for a clear understanding of the present invention. Slight changes may also be made to the shape of the components in the drawings due to, e.g., variations in manufacturing process. Thus, unless explicitly stated otherwise, the embodiments set forth herein should not be limited to the shapes shown in the drawings and it should be appreciated that some changes may be made thereto.

Meanwhile, various embodiments of the present invention may be combined with any other embodiments unless indicated otherwise. In particular, some features indicated as preferable or advantageous may be combined with other features indicated as preferable or advantageous.

When determined to make the subject matter of the present invention unclear, the detailed description of the known art or functions may be skipped.

### Embodiment 1. High-Concentration Nitrogen Wastewater Treatment Apparatus

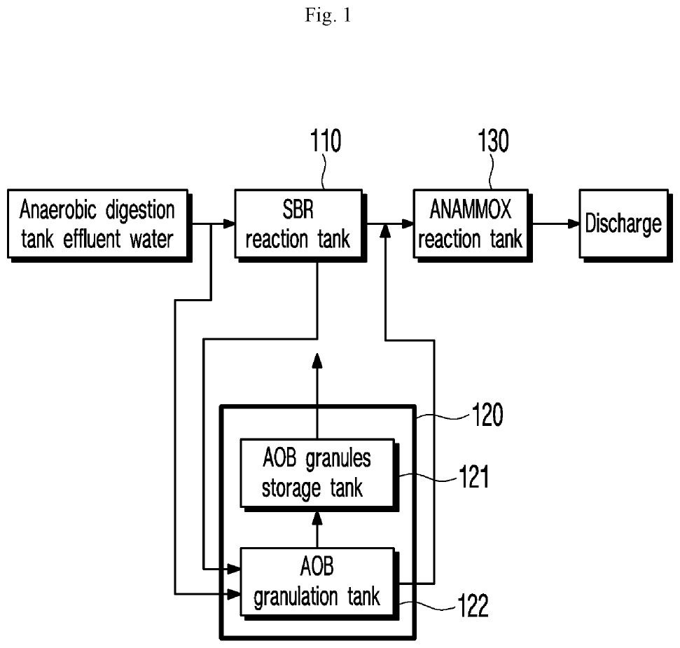

FIG. 1 is a view illustrating a short-cut nitrogen removal process for a high-concentration nitrogen wastewater treatment apparatus according to an embodiment of the present invention.

Referring to FIG. 1, a high-concentration nitrogen wastewater treatment apparatus includes, but is not limited to, an SBR reaction tank 110, an AOB granulation tank 120, and an ANAMMOX reaction tank 130.

The SBR reaction tank 110 performs partial nitritation on wastewater.

The SBR reaction tank 110 includes a pump for injecting wastewater containing high-concentration ammonia, a discharger for discharging supernatant liquid, motorized valves for discharging low-sedimentable sludge and AOB granules, an air blower for feeding air, an air lift-type air feeder 111, and an automatic operation controller. However, the present invention is not limited thereto.

The SBR reaction tank may be shaped as a cylinder measuring 35 cm in diameter, 65 cm in effective depth of water, and 60 L in effective volume. After sedimentation in the SBR reaction tank 110, the amount of supernatant liquid discharged, the amount of low-sedimentable sludge discharged, and the amount left may be 30%, 30%, and 40%, respectively, and the SBR reaction tank 110 may be operated in a sequencing batch type of 4 cycles per day, but not limited thereto.

According to an embodiment of the present invention, one cycle may be six hours in total. The time during which granules are introduced into the AOB granulation tank 121, the time during which wastewater is introduced, and the time of reaction, the time of sedimentation, the time during which supernatant liquid is discharged, and the time during which sludge is discharged may be 10 minutes, 10 minutes, 300 minutes, 20 minutes, 10 minutes, and 10 minutes, respectively.

The SBR reaction tank may be divided into three sections, and sludge only in the middle section among the three sections may be introduced into the AOB granulation tank 121, but the present invention is not limited thereto.

The AOB granulator 120 may include, but is not limited to, the AOB granulation tank 21 and the AOB granules storage tank 122.

The AOB granulation tank 121 may be configured as a cylindrical air lift-type reactor which measures 20 cm in diameter, 65 cm in effective depth of water, and 20 L in effective volume. The motorized valve for discharging treated water after sedimentation may be installed at a medium height of the AOB granulation tank 121, and the motorized valve for discharging granules may be installed at the bottom of the AOB granulation tank, but the present invention is not limited thereto.

The AOB granulation tank 121 performs partial nitritation on the introduced wastewater while simultaneously producing AOB granules.

The AOB granulation tank 121 may recover the produced AOB granules and store the AOB granules in the AOB granules storage tank 122. The AOB granules stored in the AOB granules storage tank 122 may be supplied to the SBR reaction tank 110 as the efficiency of the SBR reaction tank 110 is lowered.

The AOB granulation tank 121 may be operated while inoculating AOB-containing extra sludge into the AOB granulation tank 121 and injecting ammonia nitrogen-containing wastewater to the SBR reaction tank 110 and the AOB granulation tank 121.

The operation of the AOB granulation tank 121 may be repeatedly performed in the order of an ammonia wastewater injection step, a nitritation and AOB granule formation step, a sedimentation step, and the step of discharging low-sedimentable microorganisms and treated water.

As the wastewater introduced into the SBR reaction tank 110 and the AOB granulation tank 121, supernatant liquid in a sewage treatment plant anaerobic digester was used. The ammonia nitrogen concentration of the introduced wastewater may be, but is not limited to, 500 mg/L to 1,000 mg/L.

The time taken for introducing wastewater, aeration, sedimentation, and discharge may be varied depending on the concentration of introduced ammonia nitrogen, and three to 24 hours may be consumed for one cycle, but without limited thereto.

By maintaining a short sedimentation time of the SBR reaction tank 110, AOB granules which are well sedimentable may be positioned lower, and sludge which has poor sedimentability may be introduced into the AOB granulation tank 121, thereby enabling reproduction of high-purity AOB granules. Low-sedimentable sludge may be discharged along with the treated water and, thus, the SRT may be adjusted.

The sedimentation time of the AOB granulation tank 121 is also kept short, thus allowing high-sedimentable AOB granules to settle on the bottom of the AOB granulation tank while suspended microorganisms, which fail to form granules or are sedimented slowly, are washed out in the discharge step.

By repeating the above operations, high-sedimentable AOB granules may be formed while NOB is washed out, so that AOB may selectively take dominance. However, the present invention is not limited thereto.

An upper portion of the ANAMMOX reaction tank 130 may be filled with floating media, and a lower portion of the ANAMMOX reaction tank 130 may be configured to have any one of a completed mixed or upflow and fluidized bed biofilm process through a sludge or biofilm process.

In the fluidized bed biofilm process, a fluidized bed carrier with a specific gravity of 0.94 to 0.96 and a specific surface area of 500 m²/m³ to 800 m²/m³ may be put in a quantity in the order of 40% to 50% of the volume of the ANAMMOX reaction tank 130, but is not limited thereto.

The completed mixed moving bed biofilm process may include, but is not limited to, a stirrer for smooth fluidity of the fluidized bed carrier and a non-powered buoyant discharger for preventing leakage of the carrier and bacteria, but the present invention is not limited thereto.

### MODE FOR CARRYING OUT THE INVENTION

### Embodiment 2. Method of Operation of SBR Reaction Tank and AOB Granulation Tank

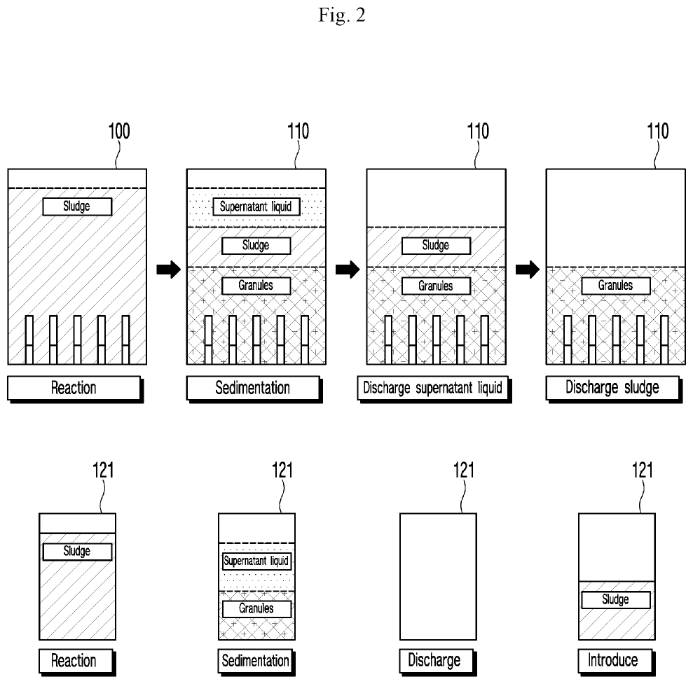

FIG. 2 is a view illustrating a method of operation of an SBR reaction tank and an AOB granulation tank according to an embodiment of the present invention.

The SBR reaction tank 110 and the AOB granulation tank 121 may be operated in a batch type, but are not limited thereto.

Reaction Step (S211)

The SBR reaction tank 110 performs a partial nitritation reaction using AOB granules. In the AOB granulation tank 121, an AOB granulation reaction is performed by low-sedimentable sludge which is introduced from the SBR reaction tank.

The SBR reaction tank 110 may use an air lift-type air feeder 111 for supplying oxygen for partial nitritation and assisting in maintaining granules, but the present invention is not limited thereto.

2) Sedimentation Step (S212)

Sedimentation starts in the SBR reaction tank 110 and the AOB granulation tank 121 where the reaction has been completed.

In the SBR reaction tank 110, supernatant liquid and sludge are separated by sedimentation. At this time, granules which are well sedimentable are positioned lower in the SBR reaction tank 110, and sludge which is of poor sedimentability is positioned higher. This is why the sedimentation speed of solids is proportional to the square of the size of the solid, and the principle applies in which larger granules are positioned lower.

In the AOB granulation tank 121, supernatant liquid and granules are separated by sedimentation.

3) Step of Discharging Supernatant Liquid (S213)

Supernatant liquid is discharged from the SBR reaction tank 110 and the AOB granulation tank 121 where sedimentation has been completed.

The SBR reaction tank 110 discharges the supernatant liquid, which is the treated water after sedimentation has been complete, to a treated water tank and the AOB granulation tank 121 discharges the supernatant liquid to the treated water tank. The AOB granules are discharged and stored in the AOB granules storage tank 122.

4) Step of Discharging Sludge (S214)

The sludge positioned over the granules in the SBR reaction tank 110 from which the supernatant liquid has been discharged is introduced into the AOB granulation tank 121.

The same AOB granulation reaction as in step S211 of Embodiment 2 occurs in the AOB granulation tank 121 where sludge has been introduced, and the operation is repeatedly performed.

### Embodiment 3. Sequential Operation Method Over Time in SBR Reaction Tank and AOB Granulation Tank

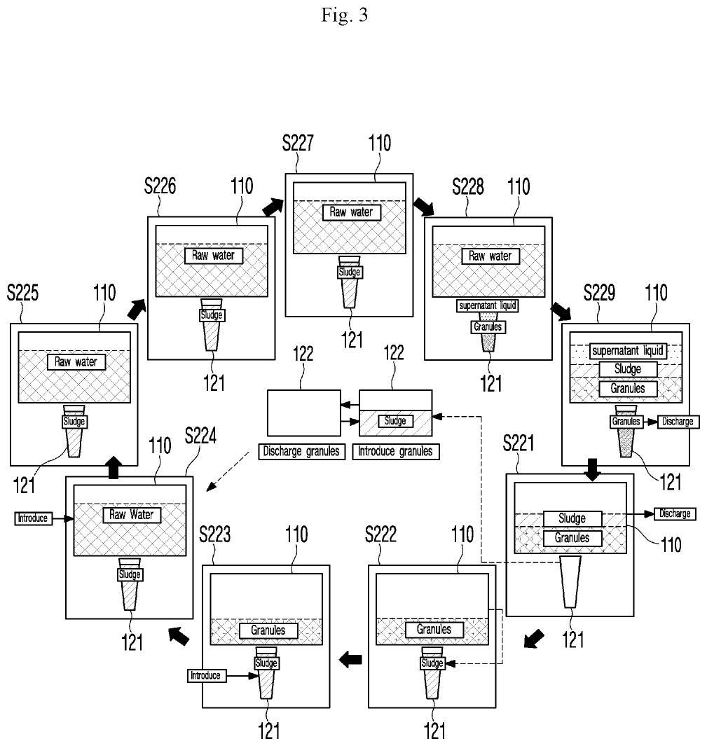

FIG. 3 is a view illustrating a method of sequential operations over time in an SBR reaction tank and an AOB granulation tank according to an embodiment of the present invention.

Step of Discharging Supernatant Liquid (S221)

The SBR reaction tank 110 discharges supernatant liquid, and the AOB granulation tank 121 discharges granules to the AOB granules storage tank 122, so that the granules are stored in the AOB granules storage tank 122.

2) Step of Discharging Sludge (S222)

The SBR reaction tank 110 discharges low-sedimentable sludge to the AOB granulation tank 121.

3) Step of Pausing SBR Reaction Tank (S223)

Ammonia nitrogen-containing wastewater (raw water) is introduced into the sludge-introduced AOB granulation tank 121. At this time, the SBR reaction tank 110 pauses.

4) Step of Introducing Wastewater (S224)

Wastewater and the AOB granules stored in the AOB granules storage tank 122 are introduced into the SBR reaction tank 110.

The granules in the AOB granules storage tank 122 are discharged to the SBR reaction tank 110.

5) Steps of Partial Nitritation and AOB Granulation (S225, S226, and S227)

A partial nitritation reaction is carried out using the AOB granules and wastewater introduced into the SBR reaction tank 110.

In the AOB granulation tank 121, the partial nitritation reaction is performed by the wastewater introduced into the AOB granulation tank 121 while AOB granules are simultaneously produced by the low-sedimentable sludge introduced from the SBR reaction tank 110.

The reaction may be performed several times depending on the amount of wastewater and sludge, but the present invention is not limited thereto.

7) Step of Sedimentation in AOB Granulation Tank (S228)

In the AOB granulation tank 121 where the formation reaction has been completed, sedimentation for solid-liquid separation proceeds, and supernatant liquid and granules are separated into the upper part and lower part, respectively, of the AOB granulation tank 121.

The partial nitritation reaction continues in the SBR reaction tank 110.

8) Step of Sedimentation in SBR Reaction Tank (S229)

In the SBR reaction tank 110 where the partial nitritation reaction has been completed, sedimentation for solid-liquid separation proceeds, and the supernatant liquid, sludge, and granules are separately positioned in the upper, middle, and lower parts, respectively, of the SBR reaction tank 110.

The AOB granulation tank 121 discharges the supernatant liquid except for the granules.

At this time, the AOB granulation tank 121 enables washing out and discharging suspended microorganisms which are less active, fail to form into granules, or low-sedimentable.

This is why as the activity of NOB is lowered by the influence of high free ammonia (FA) in the reaction tank, NOB are mostly washed out and discharged from the reaction tank, and AOB which grow slow but are relatively strong and hard and have high density, form into granules and thus settle and remain in the reaction tank despite a short sedimentation time.

Going back to the first step, i.e., S221 where supernatant liquid is discharged, the process is sequentially performed.

### Embodiment 4. High-Concentration Nitrogen Wastewater Treatment Apparatus Adding an ANAMMOX Granulation Tank

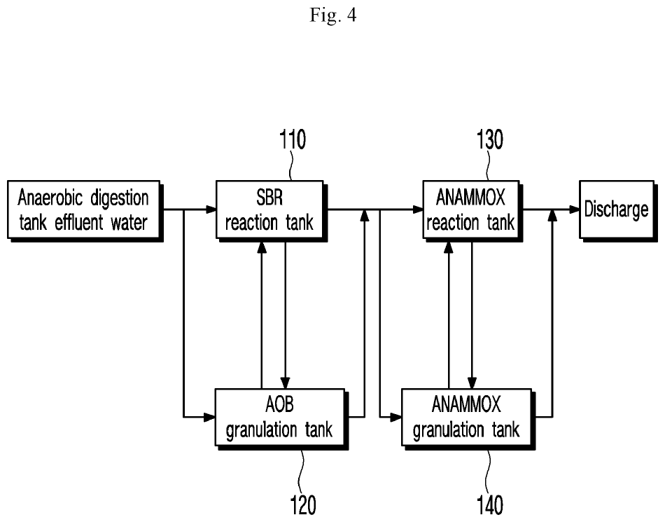

FIG. 4 is a view illustrating a short-cut nitrogen removal process adding an ANAMMOX granulation tank according to an embodiment of the present invention.

The high-concentration nitrogen wastewater treatment apparatus including the SBR reaction tank 110, the AOB granulator 120, and the ANAMMOX reaction tank 130, according to embodiment 1 may further include the ANAMMOX granulation tank 140, but the present invention is not limited thereto.

The ANAMMOX granulation tank 140 may recover tiny bacteria growing in the ANAMMOX reaction tank 130 and reproduce the recovered bacteria into granules and may separately be included in the ANAMMOX reaction tank 130, but the present invention is not limited thereto.

The ANAMMOX granulation tank 140 may produce ANAMMOX granules using a water lift type, but the present invention is not limited thereto.

As the efficiency of the ANAMMOX reaction tank 130 is lowered, the reproduced ANAMMOX granules may be supplied.

### Embodiment 5. Method of Producing AOB Granules

As an AOB granule creation reactor used according to the present invention, a known one was used.

The AOB granulation reactor may include, but is not limited to, a sequencing batch reactor including a stainless reactor shaped as a circular pipe and including an inner circular pipe to form spherical granules by the internal hydraulic shearing force, a pump to inject ammonia-containing wastewater, a motorized valve for discharging treated water, a motorized valve for discharging granules, a blower for supplying air, a chemical pump, and an automatic operation control panel.

The AOB granulation reactor may be configured to measure 0.86 m in diameter, 3.45 m in effective depth of water, and 2 m³ in effective volume, and the motorized valve for discharging treated water after sedimentation may be formed at a medium height of the reactor. The motorized valve for discharging granules may be installed at the bottom of the reactor but the present invention is not limited thereto.

As the amount of air is adjusted by an adjusting valve to be within a range from 0.01 m/s to 0.2 m/s, the operation is performed. Preferably, the operation may be performed as the amount of air is adjusted to be within a range from 0.05 m/s to 0.15 m/s, but the present invention is not limited thereto.

The area of the inner circular pipe and outer circular pipe of the reactor may be set to allow the speed of air in the inner circular pipe to be the same as the speed of air in the outer circular pipe, and the area of the upper part of the reaction tank, where a hydraulic shearing force is produced for forming granules may be set to reduce the speed of air to ¼.

The diameter-to-effective water depth height ratio of the reactor is preferably maintained to be minimally 1:3 to 4.

AOB-containing extra sludge is inoculated into the reactor and high-concentration ammonia-containing wastewater is injected to the reactor, thereby performing the operation.

The operation of the reactor repeats the step of injecting ammonia wastewater, the step of nitritation and granulation, the step of sedimentation, and the step of discharging microorganisms with poor sedimentability and treated water in the order thereof.

As the introduced wastewater, the anaerobic digestion leachate of the first sedimented sludge and second sedimented sludge in the sewage treatment plant is used and, at this time, the operation may be performed until the ammonia concentration of the introduced wastewater reaches a range from 100 mg/L to 2,500 mg/L. Preferably, the operation may be performed until the ammonia concentration reaches a range from 500 mg/L to 2,000 mg/L, but the present invention is not limited thereto.

The time taken for introduction of wastewater, aeration, sedimentation, and discharge may be varied depending on the concentration of introduced ammonia nitrogen, and three to 24 hours may be consumed for one cycle, but without limited thereto.

When the AOB granulator is operated, if the time of sedimentation remains short, AOB granules which are high sedimentable may be sufficiently settled on the bottom of the reactor, but suspended microorganisms which fail to form into granules or are low sedimentable may be washed out in the discharge step. By repeating the above operations, high-sedimentable AOB granules may be formed, so that pressure may selectively be exerted to allow AOB to take dominance. However, the present invention is not limited thereto.

According to an embodiment of the present invention, the sedimentation speed of the sequencing batch reactor may remain 10 to 60 m/h, and thus, AOB granules may selectively be accumulated, but the present invention is not limited thereto.

### Experimental Example 1: Identify the Characteristic of AOB Granulation in AOB Granulator

An experiment for AOB granulation and partial nitritation was performed in the side stream using the AOB granulation reactor of <Embodiment 5>.

The ammonia nitrogen in the first sludge anaerobic digestion leachate used in the experiment was 500 mg/L on the average, and the pH and temperature of the reactor were maintained to be 7.3 to 7.5 and 28±2° C., respectively.

Oxygen which was needed for partial nitritation was injected by a diffuser inside the reaction tank, and dissolved oxygen was maintained to be about 2 mg/L or less.

The influent water was introduced into the reactor for five minutes, and aeration and partial nitritation were performed for about 140 minutes to about 155 minutes, sedimentation was performed for about 15 minutes to about 30 minutes, and the treated water was discharged for five minutes. Thus, one cycle is done.

Here, one cycle is three hours long, and eight cycles were performed for one day.

1 m³ of the treated water which is ½ of the overall volume of the reactor is discharged, and the overall retention time is maintained to be 6 hours. The time of sedimentation may be stepwise shortened depending on the degree of AOB granulation and sedimentation, and (the testers) increased the time of aeration and performed the operation.

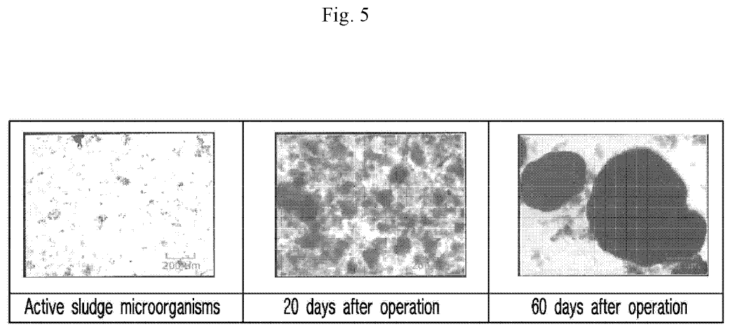

FIG. 5 illustrates photos for comparison showing variations in the size of AOB granules as an AOB granulation tank is operated according to an embodiment of the present invention.

Referring to FIG. 5, the size of granules per period in a reactor was observed under a microscope.

It is shown that the size of microorganisms in active sludge is about 10 μm to 50 μm, 20 days after the operation, granules with a size of about 100 μm formed, and 60 days after the operation, the size of granules increased up to 800 μm to 1,200 μm.

It is shown that 60 days after in the reactor of <Embodiment 5>, spherical and elliptical granules formed.

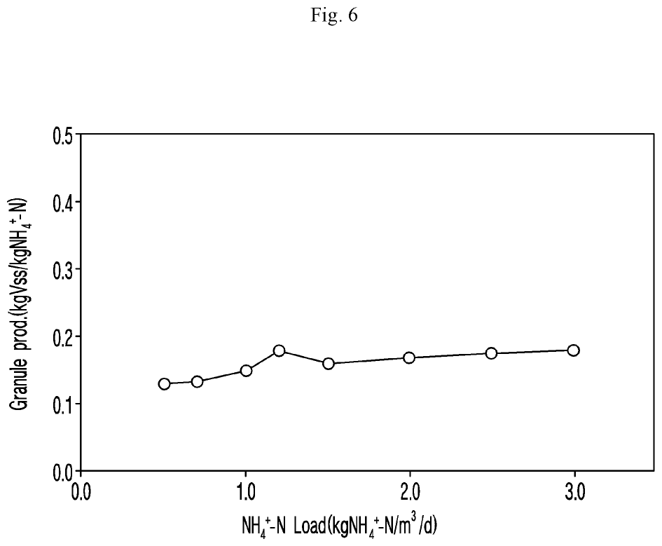

FIG. 6 is a graph illustrating the amount of AOB granules produced per ammonia removal amount under a nitrogen influx load condition in an AOB granulation tank according to an embodiment of the present invention.

Referring to FIG. 6, as organic matter is mostly removed from the anaerobic digestion tank, the substrates available to the microorganisms exist mostly in the form of ammonia nitrogen.

Thus, it can be shown that as autotrophic microorganisms spread and grow, 0.13 Kg to 0.18 Kg of AOB granules, 0.16 Kg on the average, are produced for 1 Kg of influent ammonia nitrogen.

Table 1 below shows the kinds and distribution of microorganisms in the AOB granules according to microorganism sequence listing and quantity analysis using pyrosequencing analysis during the period of operation of the AOB granule reactor.

TABLE 1

| | Nitrosomonas | Nitrosospira | Nitrobacter |
|---|---|---|---|
| Types and periods | SPP. | SPP. | SPP. |
| Early stage of operation | 1 ± 1.5% | 0.2 ± 0.3% | 3 ± 0.4% |
| 20 days of operation | 6 ± 3.0% | 2 ± 0.5% | 1.5 ± 1.3% |
| 60 days of operation | 23 ± 2.5% | 4 ± 0.5% | 0.5 ± 0.5% |

Referring to Table 1, Nitrosomonas SPP. which belong to the AOB increased from about 1% at the early stage of the operation to about 23% 60 days later the operation, and Nitrosospira SPP. increased from about 0.2% at the early stage of the operation to about 4% 60 days later.

In contrast, Nitrobacter SPP. which belong to NOB decreased from about 3% at the early stage of the operation to about 0.5% 60 days later.

Such results reveal that NOB become less active and are mostly washed out and discharged from the reactor by the influence of the high free ammonia (FA) in the AOB granule reactor.

In contrast, AOB which grow relatively slow but have a strong and hard structure with high density form into granules and, despite a short sedimentation time, settle in the reactor without being washed out. Thus, AOB granules remain in the reactor.

### Experimental Example 2: Identify the Characteristics of AOB Granules in SBR Reaction Tank Associated with AOB Granulation Tank

An AOB granulation experiment is performed by the methods of Embodiment 2 and Embodiment 3 using the AOB granulation tank 121 and the SBR reaction tank 110 as follows.

The SBR reaction tank 110 is seeded with the AOB granules produced in Experimental Example 1 and is operated.

High-concentration nitrogen wastewater used in the experiment is anaerobic digestion leachate which is a combination of livestock excretion and food waste, and the ammonia nitrogen in the wastewater is 1,500 mg/L on the average.

AOB granules in the AOB granulation tank 121 were introduced into the SBR reaction tank 110 for 10 minutes, influent water was introduced into the SBR reaction tank 110 for 10 minutes, and aeration and partial nitritation were performed for 300 minutes. Thereafter, sedimentation was performed for 20 minutes, and 10 minutes for treated water, and sludge was discharged to the AOB granulation tank 121 for 10 minutes, and thereby, one cycle was done.

Sludge discharged from the SBR reaction tank 110 was introduced into the AOB granulation tank 121, and influent water was introduced for 10 minutes, and aeration and partial nitritation were performed for 300 minutes. Thereafter, sedimentation was performed for 20 minutes, and 10 minutes for treated water, and AOB granules were discharged to the SBR reaction tank 110 for 10 minutes, and thereby, one cycle was done.

One cycle of the SBR reaction tank 110 and the AOB granulation tank 121, which was a six-hour long, and four cycles were performed for one day. The operation was performed so that ½ of the effective volume of each reaction tank was discharged and the overall retention time was maintained to be 12 hours.

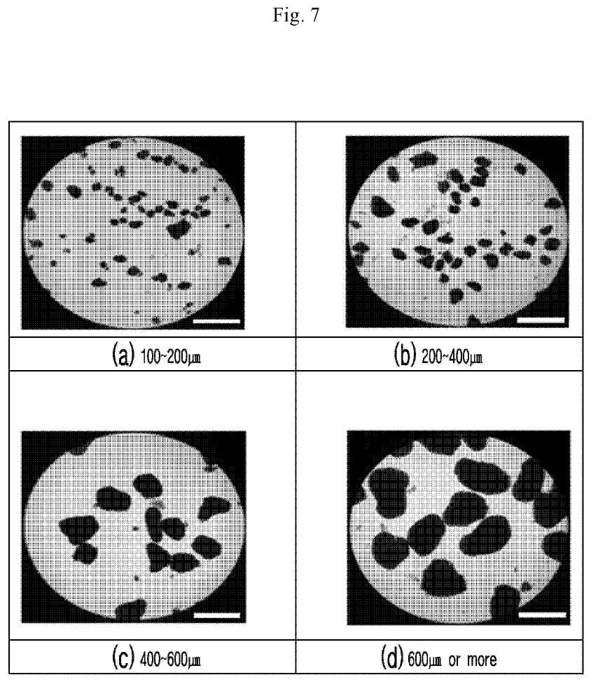

FIG. 7 illustrates microscopic photos in which AOB granules in an SBR reaction tank are classified per size according to an embodiment of the present invention.

Table 2 below shows the distribution of per-size AOB granules.

TABLE 2

| | Sizes | | | | |
|---|---|---|---|---|---|
| | | | | | 800 |
| | 100~200 | 200~400 | 400~600 | 600~800 | μm or |
| | μm | μm | μm | μm | more |
| Distribution ratio | 16.0% | 54.8% | 18.2% | 9.9% | 0.6% |

Referring to FIG. 7 and Table 2, it could be identified that the AOB granules in the SBR reaction tank 110 were produced along with the low-sedimentable granules in the AOB granulation tank 121 and exist in the spherical shapes harder than the AOB granules produced in Experimental Example 1.

Most of the AOB granules in the reaction tank are shown to have a size in the order of 200 μm to 400 μm.

Table 3 below shows the kinds and distribution of microorganisms in the AOB granules according to microorganism sequence listing and quantity analysis using pyrosequencing analysis during the period of operation of the SBR reaction tank 110.

TABLE 3

| | Nitrosomonas | Nitrosospira | Nitrobacter |
|---|---|---|---|
| Types | SPP. | SPP. | SPP. |
| Distribution ratio | 40 ± 3.5% | 2.0 ± 3.0% | 0.3 ± 0.1% |

Referring to Table 3, it can be shown that as the AOB granulation tank 121 produces low-sedimentable granules and wash out and discharge NOB and heterotrophic microorganisms which became less active, Nitrosomonas SPP. which belong to AOB substantially doubled as compared with in Table 1.

Whereas the distribution of AOB in the nitrification tank according to the conventional activated sludge process is 2% to 5% of all the microorganisms, the concentration of AOB according to an embodiment of the present invention is 10 times or more than the concentration of AOB according to the conventional activated sludge process and is two times or more than the concentration of AOB according to the conventional granulation method. AOB granulation proceeds three times or more faster than the conventional granulation method.

### Experimental Example 3: Assess Processing Efficiency Using AOB Granule-Based SBR Reaction Tank and ANAMMOX Process

The processing efficiency of high-concentration nitrogen wastewater was assessed using the AOB granulation reactor, SBR reaction tank 110, and ANAMMOX reaction tank 130 of Embodiment 1.

The SBR reaction tank 110 may be shaped as a cylinder which measures 35 cm in diameter, 65 cm in effective depth of water, and 60 L in effective volume and, after sedimentation, the amount of supernatant liquid discharged, the amount of poor-sedimentable sludge discharged, and the remaining amount were 30%, 30%, and 40%, respectively, and the operation was performed in a sequencing batch type of four cycles per day.

One cycle is six hours long in total, which means that the operation is performed; 10 minutes for introduction of AOB granules, 10 minutes for introduction of wastewater, 300 minutes for reaction, 20 minutes for sedimentation, 10 minutes for discharging supernatant liquid, and 10 minutes for discharging sludge.

The AOB granulation tank 121 may be configured as a cylindrical air lift-type reactor which measures 20 cm in diameter, 65 cm in effective depth of water, and 20 L in effective volume and was operated in a sequencing batch type of four cycles per day in association with the SBR reaction tank 110.

The ANAMMOX reaction tank 130 may be configured as a cylinder which measures 25 cm in diameter, 50 cm in effective depth of water, and 20 L in effective volume. A stirrer was installed inside the reaction tank for fluidized bed carrier and completed stirring, the retention time was maintained to be 12 hours, and the operation was performed in a continuous flow type.

For assessing the processing efficiency, effluent water was used which was in the resource recovery process in which livestock excretion and food waste flowing in the public livestock excretion treatment facility of Y city and methane was recovered by anaerobic digestion.

The pH of effluent water in the combined anaerobic digestion process is 8.0, TCODMn is 2,000 mg/L, T-N is 2,000 mg/L, and NH₄—N is 1,700 mg/L. The COD components in the wastewater are mostly non-degradable components and are difficult to treat by normal nitrification/denitrification without an external carbon source.

The effluent water which has undergone the SBR reaction tank 110 and the ANAMMOX reaction tank 130 in the assessment process of Experimental Example 3 was evaluated as follows.

Table 4 below shows mean values in the stable during the experiment period.

TABLE 4

| | | SBR | ANAMMOX | removal |
|---|---|---|---|---|
| | influent | reaction | reaction | efficiency |
| Types | water | tank | tank | (%) |
| pH | 8.0 | 7.2 | 7.9 | — |
| TCOD_{Mn} | 2,000 | 1,715 | 1,432 | 28.4 |
| T-N | 2,000 | 1,872 | 439 | 78.1 |
| TKN | 2,000 | 978 | 295 | 85.3 |
| NH₄—N | 1,700 | 793 | 110 | 93.5 |
| NO₂—N | 0 | 831 | 13 | — |
| NO₃—N | 0 | 63 | 131 | — |

Referring to Table 4, about 44.4% of the total nitrogen amount in the effluent water of the SBR reaction tank was transformed into nitrite nitrogen and about 3% was transformed into nitrate nitrogen.

It is shown that the ratio of ammonia to nitrite nitrogen by partial nitritation is 1:1.05.

It is shown that the consumption ratio of ammonia to nitrite nitrogen in the effluent water of the ANAMMOX reaction tank is 1:1.2 and extra nitrate nitrogen of about 10% was produced.

The overall result of assessing the processing efficiency in association with the ANAMMOX reaction tank 130 and the SBR reaction tank 110 using AOB granules reveals that 78.1% of the total nitrogen amount was removed without an external carbon source.

Further, if partial nitritation on high-concentration nitrogen wastewater is sufficiently complete, the oxygen consumption rate may be reduced up to 60% and the organic matter necessary for denitrification may be 100% reduced as compared with the conventional nitrification-denitrification process.

### INDUSTRIAL AVAILABILITY

The present invention relates to a high-concentration nitrogen wastewater treatment apparatus using an SBR reaction tank and an ANAMMOX process in association with an AOB granulation tank. The present invention adopts a short-cut nitrogen removal process which oxidizes only part of ammonia nitrogen up to the nitritation step and removes nitrogen using denitrification, thereby saving oxygen and organic matter as compared with the conventional method and reducing sludge production and hence making it industrially applicable.

1. A wastewater treatment apparatus, comprising a partial nitritation sequencing batch reactor (SBR) reaction tank for partial nitritation, an AOB granulator including an ammonium oxidation bacteria (AOB) granules storage tank and an AOB granulation tank for producing high-purity AOB granules, and an anaerobic ammonium oxidation (ANAMMOX) reaction tank, wherein the SBR reaction tank is operated to achieve only nitritation to allow AOB microorganisms to take dominance and, after the reaction is complete, AOB granules and sludge are separated from each other by sedimentation, and then only the sludge is introduced into the AOB granulation tank to produce good granules, wherein the good granules are re-introduced into the SBR reaction tank and are subjected to stable partial nitritation, and then nitrogen is removed therefrom by short-cut nitrogen removal reaction using the ANAMMOX reaction tank.

2. The wastewater treatment apparatus of claim 1, wherein the SBR reaction tank is divided into three sections, and only sludge in the middle section is introduced into the AOB granulation tank.

3. The wastewater treatment apparatus of claim 1, wherein the SBR reaction tank includes an air lift-type air feeder which advantageously maintains granules.

4. The wastewater treatment apparatus of claim 1, wherein the ANAMMOX reaction tank includes an upper portion filled with floating media and a lower portion including any one of a completed mixed or upflow and fluidized bed biofilm process through a sludge granule or biofilm process.

5. The wastewater treatment apparatus of claim 4, wherein the fluidized bed biofilm process includes putting a fluidized bed carrier with a specific gravity of 0.94 to 0.96 and a specific surface area of 500 m²/m³ in 40 volume % to 50 volume % of the reaction tank.

6. The wastewater treatment apparatus of claim 4, wherein the completed mixed moving bed biofilm process includes a stirrer for smooth fluidity of the fluidized bed carrier and a non-powered buoyant discharger for preventing leakage of the carrier and bacteria.

7. A high-concentration nitrogen wastewater treatment apparatus, comprising:
a partial nitritation sequencing batch reactor (SBR) reaction tank for partial nitritation;
an ammonium oxidation bacteria (AOB) granulator including an AOB granules storage tank and an AOB granulation tank for producing high-purity AOB granules;
an anaerobic ammonium oxidation (ANAMMOX) reaction tank; and
an ANAMMOX granulation tank.

8. The high-purity nitrogen wastewater treatment apparatus of claim 7, wherein the ANAMMOX granulation tank uses a water lift type for mixing necessary for producing granules.
